(19) United States
(12) Patent Application Publication
(10) Pub. No.: US 2026/0009991 A1
(43) Pub. Date: Jan. 8, 2026

(54) A TILING LIGHT SHEET MICROSCOPE, ITS IMAGING METHOD, MICROSCOPY SYSTEM AND A DETECTION CAMERA

(71) Applicant: NUOHAI LIFE SCIENCE (SHANGHAI) CO., LTD, Shanghai (CN)

(72) Inventor: Liang GAO, Zhejiang (CN)

(21) Appl. No.: 19/134,270

(22) PCT Filed: Nov. 30, 2022
(86) PCT No.: PCT/CN2022/135273

§ 371 Date: May 30, 2025

(51) Int. Cl. G02B 21/06; G02B 21/36; G02B 26/10; H04N 25/531

(52) U.S. Cl. CPC G02B 21/06; G02B 21/361; G02B 26/10; H04N 25/531

(57) ABSTRACT

A tiling light sheet microscope (TLSM), its imaging method and a corresponding microscopy system is provided. The TLSM includes a SLM for performing phase modulation on an excitation laser beam, a galvanometer, an excitation objective, and a detection camera. The SLM is configured to: load a combined phase map to apply the corresponding phase map to each group of pupil segments of the rear pupil of the excitation objective, so as to create a non-coaxial excitation beam array with the excitation laser beams separated along the scanning direction. The galvanometer is configured to scan the non-coaxial excitation beam array synchronized with the sweeping of the multiple regional virtual confocal slits controlled by the detection camera, so as to generate discontinuous light sheets for illumination of the imaging plane. It can both improve the imaging efficiency of TLSM and relax the synchronization requirement for using discontinuous light sheets in TLSM.

### TECHNICAL FIELD

The present disclosure relates to a precision optical instrument, a use method thereof and a system including same, and in particular to a tiling light sheet microscope, its imaging method and a corresponding microscopy system.

### BACKGROUND

The 3D imaging ability of selective plane illumination microscopy (SPIM), i.e., light sheet microscopy (LSM), relies on the intensity profile of the excitation light sheet. The thickness, light confinement ability and size of the excitation light sheet determine the axial resolution, optical sectioning ability and the size of the field of view (FOV) respectively. Thus, confining the illumination light both near the imaging plane as much as possible and along the light propagation direction as far as possible at the same time is required to achieve a high 3D imaging ability over a large FOV in LSM.

Despite the efforts spent to optimize the intensity profile of the excitation light sheet in LSM, the diffraction of light makes it impossible to reduce the light sheet thickness, improve the light confinement ability and increase the light sheet size at the same time. Therefore, methods other than optimizing the light sheet intensity profile were developed to solve the problem. An effective strategy is to tile (move) the excitation light sheet quickly along the light propagation direction within the imaging plane, so that both high spatial resolution and good optical sectioning ability can be achieved in a FOV much larger than the size of the light sheet itself. Tiling light sheet microscopy (TLSM) uses this strategy to improve the 3D imaging ability of LSM for imaging large samples.

In TLSM, a large imaging plane is imaged by tiling a short but thin light sheet at multiple positions within the imaging plane and taking an image at each tiling position. The final image is reconstructed using the raw images collected at all tiling positions. It has been demonstrated that TLSM has a much better 3D imaging ability than conventional LSM in imaging large samples, ranging from live embryonic specimens to optically cleared biological tissues. In addition, TLSM allows adjusting the intensity profile and tiling positions of the excitation light sheet and correcting the excitation light sheet alignment errors easily, so that the 3D imaging ability of TLSM can be optimized in real-time based on the sample and imaging requirements in various applications. Despite the advanced 3D imaging ability of TLSM, the extra camera exposures required by TLSM cause a problem. The imaging speed decreases, and the raw data size increases proportionally to the number of tiles, i.e., the number of camera exposures required per image plane. The problem is troubling when both high 3D imaging ability and high imaging throughput are both required for 3D imaging of large samples using TLSM.

In our previous research, we developed a method using discontinuous light sheets to improve the imaging efficiency of TLSM without sacrificing its 3D imaging ability. In the method, discontinuous light sheets are created by scanning coaxial beam arrays synchronized with a virtual confocal slit controlled by the rolling shutter of the detection camera, and are used to illuminate the imaging plane, see “D. Wang, Y. Jin, R. Feng, Y. Chen, L. Gao, “Tiling light sheet selective plane illumination microscopy using discontinuous light sheets,” Opt Express., 27(23), 34472-34483 (2019)”. It is verified that the use of discontinuous light sheets improves the imaging efficiency and reduce the raw data size of TLSM by imaging more effective areas of the imaging plane at each tile without affecting the spatial resolution and optical sectioning ability.

However, the optical alignment is very critical to use discontinuous light sheets created by scanning coaxial beam arrays for sample illumination in TLSM, as the synchronization of the scanning coaxial beam array with the global (single) virtual confocal slit controlled by the detection camera (which is only several microns wide) must always be ensured, as shown in FIG. 1. In the applications of discontinuous light sheets for imaging large cleared biological tissues, we found it often difficult to satisfy the synchronization requirement for several reasons. First, the synchronization is very sensitive to microscope misalignment. Any misalignment could break the synchronization. Second, the samples are not always perfectly transparent or uniform. The optical aberrations introduced by the sample could also violate the synchronization and reduce the imaging quality. Finally, it is particularly challenging when high spatial resolutions are desired, which often requires the synchronization of the scanning coaxial beam array and a narrow virtual confocal slit of only a few microns wide that is corresponding to only a few pixel rows on the detection camera. Particularly, the scanning coaxial beam array must be synchronized with a virtual confocal slit that is narrow enough to block the off-focus fluorescence background generated by the coaxial beam array, in which the virtual confocal slit is controlled by the rolling shutter of the sCMOS detection camera.

The present disclosure is provided to solve the above-mentioned defects in the background.

### SUMMARY

Therefore, there is a need for a tiling light sheet microscope, its imaging method and a corresponding microscopy system, which can both improve the imaging efficiency of TLSM and relax the synchronization requirement for using discontinuous light sheets in TLSM.

According to a first aspect of the present disclosure, a TLSM is provided. The TLSM comprises a spatial light modulator (SLM) for performing phase modulation on the excitation laser beam, a galvanometer, an excitation objective, and a detection camera. The optical modulation plane of the SLM is conjugated to the rear pupil of the excitation objective. The SLM is configured to: load a combined phase map to apply the corresponding phase map to each group of pupil segments of the rear pupil of the excitation objective in order to create a non-coaxial excitation beam array with the excitation beams separated along both the excitation light propagation direction and the beam array scanning direction. The rear pupil comprises multiple groups of pupil segments and the excitation beams are created by different groups of pupil segments respectively. The detection camera is configured to perform the exposure by sweeping multiple regional virtual confocal slits. The galvanometer is configured to scan the non-coaxial excitation beam array synchronized with the sweeping of the regional virtual confocal slits. Scanning of each excitation beam is synchronized with sweeping of one of the regional virtual confocal slits, so as to generate discontinuous light sheets for illumination of the imaging plane.

According to a second aspect of the present disclosure, an imaging method of a TLSM is provided. The TLSM comprises a spatial light modulator (SLM) for performing phase modulation on the excitation laser beam, a galvanometer, an excitation objective, and a detection camera. The optical modulation plane of the SLM is conjugated to the rear pupil of the excitation objective. The imaging method comprises the follows steps. A combined phase map is loaded to the SLM to apply the corresponding phase map to each group of pupil segments of the rear pupil of the excitation objective, so as to create a non-coaxial excitation beam array with the excitation beams separated along both the excitation light propagation direction and the beam array scanning direction. The rear pupil comprises multiple groups of pupil segments and the excitation beams are created by the different groups of pupil segments respectively. The exposure is performed by sweeping multiple regional virtual confocal slits, and the scanning of the non-coaxial excitation beam array is synchronized with the sweeping of the regional virtual confocal slits, so as to generate discontinuous light sheets to image the imaging plane.

According to a third aspect of the present disclosure, a TLSM system is provided. The system may comprise the TLSM according to any embodiment of the present disclosure and at least one processor. The at least one processor is configured to simulate the combined phase map by calculating the sum of the phase maps to be loaded to the multiple groups of pupil segments weighted with the corresponding amplitude masks.

According to a fourth aspect of the present disclosure, a detection camera is provided. The detection camera includes a camera sensor, at least one rolling shutter, and at least one controller, the at least one controller is configured to control the at least one rolling shutter to perform the sweeping of multiple regional virtual confocal slits, which are able to be separated from each other along the sweeping direction of the regional virtual confocal slits.

With the tiling light sheet microscope, its imaging method, a corresponding microscopy system, and the detection camera, present invention can both improve the imaging efficiency of TLSM and relax the synchronization requirement for using discontinuous light sheets in TLSM.

### BRIEF DESCRIPTION OF THE DRAWINGS

In figures that are not necessarily drawn to scale, the same reference numerals may describe similar components in different figures. The same reference signs with suffixes or different suffixes may denote different examples of similar components. The figures generally show various embodiments by way of example rather than limitation, and are used together with the description and the claims to describe the embodiments of the present disclosure. Such embodiments are illustrative, and are not intended to be exhaustive or exclusive embodiments of the present device or method.

FIG. 1 shows the working mechanism of the imaging plane illumination in TLSM in the prior art;

FIG. 2 shows the working mechanism of the imaging plane illumination in TLSM according to a first embodiment of the present disclosure;

FIG. 3 shows the outline optical configuration of the TLSM, which generates the non-coaxial beam arrays, according to a second embodiment of the present disclosure;

FIG. 4 shows the schematic optical configuration of the TLSM according to a third embodiment of the present disclosure;

FIG. 5(a), FIG. 5(b), FIG. 5(c), FIG. 5(d) show the amplitude masks of four groups of pupil segments respectively according to a fourth embodiment of the present disclosure;

FIG. 6(a), FIG. 6(b), FIG. 6(c), FIG. 6(d) show the continuous phase maps applied to the four groups of pupil segments respectively according to the fourth embodiment of the present disclosure;

FIG. 7(a), FIG. 7(b), FIG. 7(c), FIG. 7(d) show the binary phase maps applied to the four groups of pupil segments respectively according to the fourth embodiment of the present disclosure;

FIG. 8 shows the combined continuous phase map used to generate the four-beam non-coaxial beam array as shown in FIG. 10 and FIG. 11 according to the fourth embodiment of the present disclosure;

FIG. 9 shows the combined binary phase map used to generate the four-beam non-coaxial beam array as shown in FIG. 10 and FIG. 11 according to the fourth embodiment of the present disclosure;

FIG. 10 shows the XY maximal intensity projections (MIP) of the four-beam non-coaxial beam array according to the fourth embodiment of the present disclosure;

FIG. 11 shows the YZ maximal intensity projections (MIP) of the four-beam non-coaxial beam array according to the fourth embodiment of the present disclosure;

FIG. 12(a) shows the XY MIP of the non-coaxial beam array with a reference intensity file of all beams, the corresponding applied continuous phase map and binary phase map according to a fifth embodiment of the present disclosure;

FIG. 12(b) shows the XY MIP of the non-coaxial beam array tiled at a different position, the corresponding applied continuous phase map and binary phase map according to a modified embodiment of the present disclosure;

FIG. 12(c) shows the XY MIP of the non-coaxial beam array with a different beam period from that shown in FIG. 12(a), the corresponding applied continuous phase map and binary phase map according to a modified embodiment of the present disclosure;

FIG. 12(d) shows the XY MIP of the non-coaxial beam array with a different gap distance from that shown in FIG. 12(a), the corresponding applied continuous phase map and binary phase map according to a modified embodiment of the present disclosure;

FIG. 12(e) shows the XY MIP of the non-coaxial beam array with an individual beam with different property from that of the other beams, the corresponding applied continuous phase map and binary phase map according to a modified embodiment of the present disclosure;

FIG. 12(f) shows the XY MIP of the non-coaxial beam array with different beam number from that shown in FIG. 12(a), the corresponding applied continuous phase map and binary phase map according to a modified embodiment of the present disclosure;

FIG. 13(a) shows the XY MIP of a four-beam non-coaxial beam array with 500 μm period and 80 μm gap distance according to a sixth embodiment of the present disclosure;

FIG. 13(b) shows the regional virtual confocal slits with variable widths in the X direction according to the sixth embodiment of the present disclosure;

FIG. 13(c) shows the YZ MIP of the discontinuous light sheet obtained by scanning the non-coaxial beam array in FIG. 13(a) without slits and the intensity profiles at the positions indicated by the dashed lines;

FIG. 13(d) shows the YZ MIP of the discontinuous light sheet obtained by scanning the non-coaxial beam array in FIG. 13(a) synchronized with the regional virtual confocal slits in FIG. 13(b) of 220 μm slit width and the intensity profiles at the positions indicated by the dashed lines;

FIG. 13(e) shows the YZ MIP of the discontinuous light sheet obtained by scanning the non-coaxial beam array in FIG. 13(a) synchronized with the regional virtual confocal slits in FIG. 13(b) of 150 μm slit width and the intensity profiles at the positions indicated by the dashed lines;

FIG. 13(f) shows the YZ MIP of the discontinuous light sheet obtained by scanning the non-coaxial beam array in FIG. 13(a) synchronized with the regional virtual confocal slits in FIG. 13(b) of 120 μm slit width and the intensity profiles at the positions indicated by the dashed lines;

FIG. 13(g) shows the YZ MIP of the discontinuous light sheet obtained by scanning the non-coaxial beam array in FIG. 13(a) synchronized with the regional virtual confocal slits in FIG. 13(b) of 15 μm slit width and the intensity profiles at the positions indicated by the dashed lines;

FIG. 14(a) shows the XY MIP of a four-beam non-coaxial beam array with 500 μm period and 40 μm gap distance according to a seventh embodiment of the present disclosure;

FIG. 14(b) shows the regional virtual confocal slits with variable widths in the X direction according to the seventh embodiment of the present disclosure;

FIG. 14(c) shows the YZ MIP of the discontinuous light sheet obtained by scanning the non-coaxial beam array in FIG. 14(a) without slits and the intensity profiles at the positions indicated by the dashed lines;

FIG. 14(d) shows the YZ MIP of the discontinuous light sheet obtained by scanning the non-coaxial beam array in FIG. 14(a) synchronized with the regional virtual confocal slits in FIG. 14(b) of 150 μm slit width and the intensity profiles at the positions indicated by the dashed lines;

FIG. 14(e) shows the YZ MIP of the discontinuous light sheet obtained by scanning the non-coaxial beam array in FIG. 14(a) synchronized with the regional virtual confocal slits in FIG. 14(b) of 75 μm slit width and the intensity profiles at the positions indicated by the dashed lines;

FIG. 14(f) shows the YZ MIP of the discontinuous light sheet obtained by scanning the non-coaxial beam array in FIG. 14(a) synchronized with the regional virtual confocal slits in FIG. 14(b) of 60 μm slit width and the intensity profiles at the positions indicated by the dashed lines;

FIG. 14(g) shows the YZ MIP of the discontinuous light sheet obtained by scanning the non-coaxial beam array in FIG. 14(a) synchronized with the regional virtual confocal slits in FIG. 14(b) of 15 μm slit width and the intensity profiles at the positions indicated by the dashed lines;

FIG. 15(a) shows the XY MIP of a four-beam non-coaxial beam array with 500 μm period and 80 μm gap distance according to an eighth embodiment of the present disclosure;

FIG. 15(b) shows the regional virtual confocal slits with variable widths in the X direction according to the eighth embodiment of the present disclosure;

FIG. 15(c) shows the YZ MIP of the discontinuous light sheet obtained by scanning the non-coaxial beam array in FIG. 15(a) without slits and the intensity profiles at the positions indicated by the dashed lines;

FIG. 15(d) shows the YZ MIP of the discontinuous light sheet obtained by scanning the non-coaxial beam array in FIG. 15(a) synchronized with the regional virtual confocal slits in FIG. 15(b) of 120 μm slit width and the intensity profiles at the positions indicated by the dashed lines;

FIG. 15(e) shows the YZ MIP of the discontinuous light sheet obtained by scanning the non-coaxial beam array in FIG. 15(a) synchronized with the regional virtual confocal slits in FIG. 15(b) of 90 μm slit width and the intensity profiles at the positions indicated by the dashed lines;

FIG. 15(f) shows the YZ MIP of the discontinuous light sheet obtained by scanning the non-coaxial beam array in FIG. 15(a) synchronized with the regional virtual confocal slits in FIG. 15(b) of 15 μm slit width and the intensity profiles at the positions indicated by the dashed lines;

FIG. 16 shows the working mechanism of the global virtual confocal slit that is controlled by the global rolling shutter of the detection camera according to the ninth embodiment of the present disclosure;

FIG. 17 shows the working mechanism of the multiple regional virtual confocal slits by adopting multiple rolling shutters that control different regional virtual confocal slits separately;

FIG. 18(a) shows a first example of the implementation of multiple regional confocal slits by means of a single detection camera that is capable to control the camera exposure with multiple rolling shutters;

FIG. 18(b) shows a second example of the implementation of multiple regional confocal slits by means of multiple detection cameras that is capable to control the camera exposure with their own global rolling shutters respectively;

FIG. 18(c) shows a third example of the implementation of multiple regional confocal slits by means of a single detection camera that is capable to control the camera exposure with its own single global rolling shutter; and

FIG. 19 shows the flowchart of the imaging method of a TLSM according to the tenth embodiment of the present disclosure.

### DETAILED DESCRIPTION

In order to enable those skilled in the art to better understand the technical solutions of the present disclosure, the present disclosure will be described in detail below in conjunction with the accompanying drawings and specific embodiments. The embodiments of the present disclosure will be described in further detail below in conjunction with the accompanying drawings and specific embodiments, but they are not intended to limit the present disclosure.

“First”, “second” and similar words used in the present disclosure do not indicate any order, quantity or importance, but are only used to distinguish different components. “Include” or “comprise” and other similar words mean that an element appearing before this word covers an element listed after this word, but do not exclude other elements. The “Z-axis” direction used in this disclosure indicates the direction of the detection optical axis, i.e., the sample depth direction. The “X-axis” direction indicates the extension direction of an excitation light sheet, i.e., the scanning direction of the excitation beams. And the “Y-axis” direction indicates the propagation direction of excitation light.

In addition, although exemplary embodiments have been described herein, the scope thereof includes any and all embodiments based on the present disclosure having equivalent elements, modifications, omissions, combinations (e.g., scenarios where various embodiments intersect), adaptations, or changes. The elements of the claims will be construed broadly based on the language employed in the claims and are not limited to the examples described in this specification or during implementation of this application, the examples of which will be construed as non-exclusive. Accordingly, this specification and the examples are intended to be considered as examples only and the true scope and spirit are indicated by the full scope of the following claims and their equivalents.

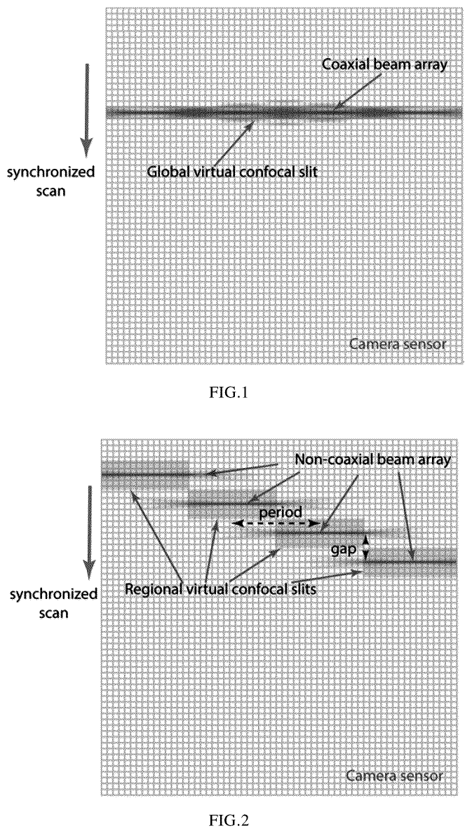

FIG. 2 shows the working mechanism of the imaging plane illumination in TLSM according to a first embodiment of the present disclosure. As shown in FIG. 2, the exposure of the detection camera is controlled by multiple regional virtual confocal slits instead of a global virtual confocal slit as that in regular sCMOS cameras (see FIG. 1). A discontinuous light sheet, created by scanning a non-coaxial beam array instead of a coaxial beam array is used to illuminate the imaging plane. In the non-coaxial beam array, the excitation beams have a period and locate in the same imaging plane but separated with a gap along the scanning direction, as shown in FIG. 2. The separation of the excitation beams along the scanning direction can not only reduce the crosstalk between them but also enable them to stay closer along the excitation light propagation direction due to the reduced crosstalk. In consequence, non-coaxial beam arrays could contain more excitation beams and have less crosstalk between the excitation beams at the same time in comparison to coaxial beam arrays, so that a higher imaging efficiency could be achieved.

The scanning of each beam within the non-coaxial beam array is synchronized with sweeping of one of the multiple regional virtual confocal slits during imaging. That is to say, the detection camera performs the exposing according to the scanning timing of the non-coaxial beam array instead of remaining exposing during the entire beam array scanning process. In this manner, the off-focus fluorescence background, which is accumulated and created by the fluorescence generated by the non-coaxial beam array, is blocked.

Instead of using a global virtual confocal slit, multiple regional virtual confocal slits are adopted to match the non-coaxial beam array and thus reject the off-focus fluorescence created by the excitation beams within the beam array. There are two considerations. First, the excitation beams within a non-coaxial beam array don't align, so that it is natural to use multiple virtual confocal slits matching the intensity profile of the non-coaxial beam array to block the off-focus fluorescence efficiently without affecting the in-focus fluorescence. Second, as the excitation beams in a non-coaxial beam array are separated along the scanning direction, it is therefore possible to increase the width of the regional virtual confocal slits without admitting additional off-focus fluorescence.

As both the excitation beams within the beam array and the regional virtual confocal slits are separated along the scanning direction, the width of the regional virtual confocal slits can be much wider than that of the global virtual confocal slit when scanning coaxial beam arrays are used to illuminate the imaging plane without admitting extra off-focus fluorescence background. Therefore, the synchronization could be much easier to achieve and maintain in practice. In this manner, compared to scanning the coaxial beam array combined with the utilization of a single global virtual confocal slit, the imaging efficiency of TLSM is improved, and the synchronization requirement for using discontinuous light sheets in TLSM could be relaxed. Meanwhile the spatial resolution is s maintained and the amount of raw data is reduced.

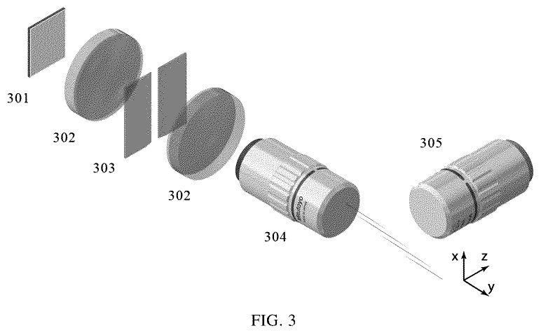

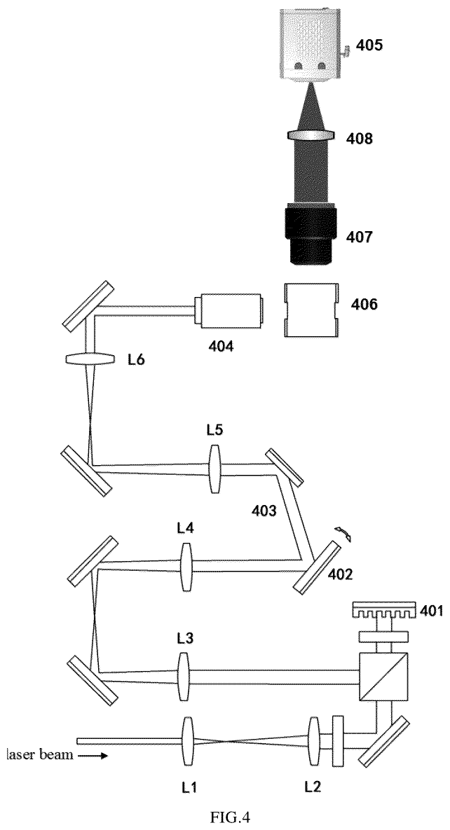

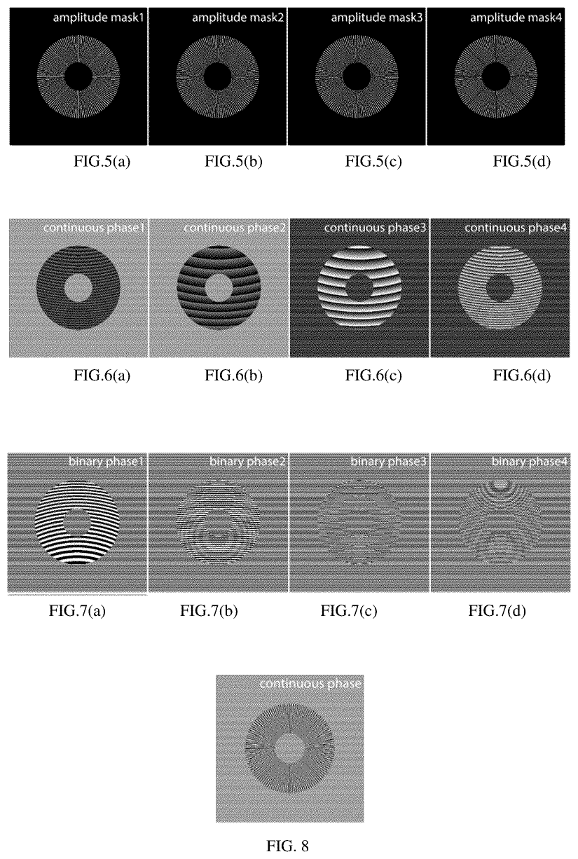

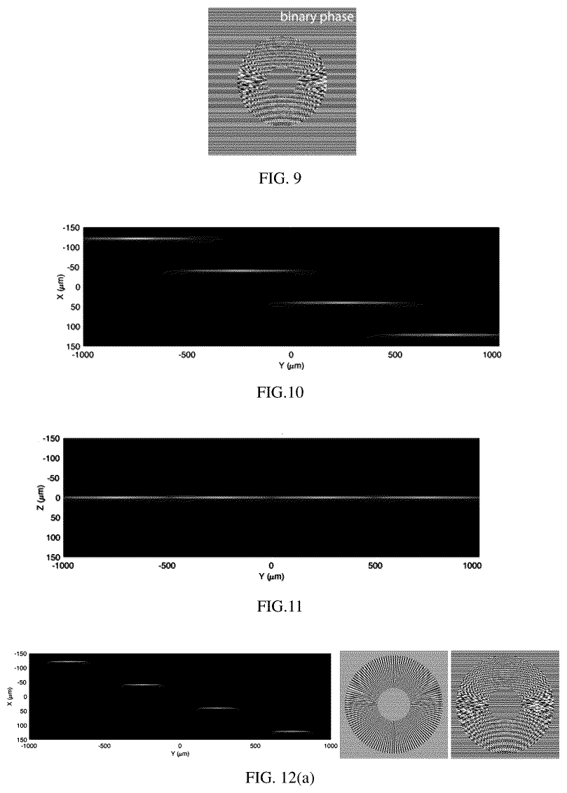

FIG. 3 shows the outline optical configuration of the TLSM, in which non-coaxial beam arrays can be used for imaging according to a second embodiment of the present disclosure. As shown in FIG. 3, the non-coaxial beam array can be generated using a spatial light modulator (SLM) 301 conjugated to the rear pupil of the excitation objective in TLSM, in which the SLM 301 can be either a continuous phase SLM or a binary phase SLM. The phase maps applied to the SLM can be calculated using a pupil segmentation method. Hereinafter, the details of the pupil segmentation method will be provided by referring to FIG. 5(a)-FIG. 5(d), FIG. 6(a)-FIG. 6(d), FIG. 7(a)-FIG. 7(d), FIG. 8, and FIG. 9. Besides, the pupil segmentation method described in our previous publication, i.e., “D. Wang, Y. Jin, R. Feng, Y. Chen, L. Gao, “Tiling light sheet selective plane illumination microscopy using discontinuous light sheets,” Opt Express., 27(23), 34472-34483 (2019)”, could also be incorporated and adopted here.

As shown in FIG. 3, an excitation objective 304 is provided at an end of the illumination path including the SLM 301, the lens 302, the optical slit 303, etc., and the detection objective 305 is provided with its axis at the Z-axis direction (depth direction). In this manner, the light sheet orthogonal to the depth direction is generated by scanning the non-coaxial beam array and used to illuminate the imaging plane of the sample, and the sample is observed by means of the detection objective 305.

FIG. 4 shows the schematic optical configuration of the TLSM according to a third embodiment of the present disclosure. As shown in FIG. 4, the TLSM comprises a SLM 401 for performing phase modulation on an excitation beam, a galvanometer 402, and an excitation objective 404, and a detection camera 405. As shown in FIG. 4, the sample to be imaged is accommodated in the imaging chamber 406, and the excitation light sheet is utilized to illuminate the sample (especially the imaging plane) and produce fluorescence. The fluorescence signal from the illuminated imaging plane is acquired and imaged by means of the detection object 407, the tube lens 408 and the detection camera 405 in sequence. Particularly, at least on one side of the imaging chamber 406, an illumination path 403 is formed by means of the corresponding optical components, such as L1, L2, the SLM 401, L3, L4, the galvanometer 402, L5, L6, and the excitation objective 404 at the end of the illumination path 403.

The optical modulation plane of the SLM 401 is set to be conjugated to the rear (entrance) pupil of the excitation objective 404 and is configured to modulate illumination light. Specifically, the SLM 401 is configured to load a combined phase map, which is obtained by simulation in advance, to apply the corresponding phase map to each group of pupil segments of the rear pupil of the excitation objective 404, so as to create a non-coaxial excitation beam array with the excitation beams separated along the beam array scanning direction (sometimes also separated along the light propagation direction), as shown in FIG. 3. Wherein the rear pupil comprises multiple groups of pupil segments and the excitation beams are created corresponding to the different groups of pupil segments. The detection camera 405 is configured to perform the exposure by sweeping multiple regional virtual confocal slits, as shown in FIG. 2.

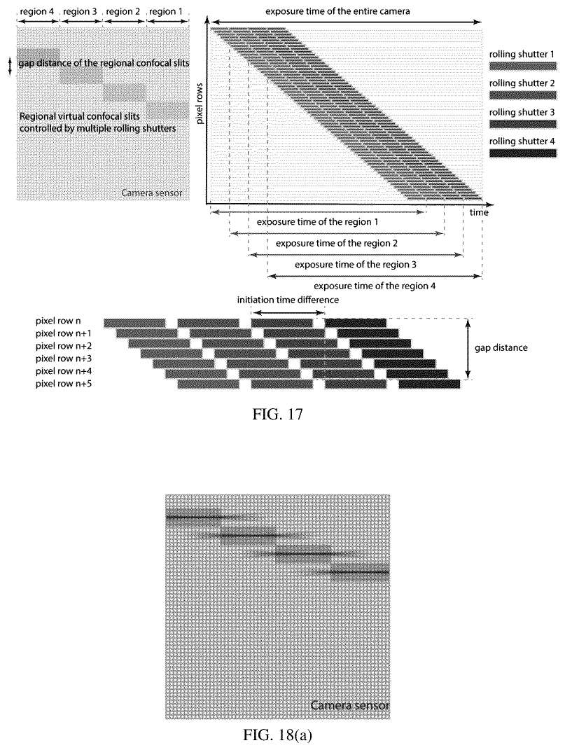

The galvanometer 402 is configured to scan the non-coaxial excitation beam array that is also synchronized with the sweeping of the regional virtual confocal slits as shown in FIG. 2, so as to generate a corresponding light sheet. Particularly, scanning of each excitation beam is synchronized with sweeping of the corresponding one of the multiple regional virtual confocal slits. In some embodiments, the galvanometer 402 is further configured to: scan the non-coaxial excitation beam array, so that the scanning of each excitation beam within the non-coaxial excitation beam array is synchronized with the sweeping timing of the corresponding virtual confocal slit controlled by the detection camera 405. Particularly, the scanning is performed synchronously based on the timing of the exposure and readout of different numbers of pixel rows (as shown in FIG. 16 and FIG. 17 hereinafter) to achieve multiple virtual confocal slits with an adjustable width.

The method can be implemented with the existing configuration of a conventional TLSM with changes including the generation of the phase map applied to the SLM 401 and modifications to the exposure mechanism of the detection camera 405, especially its recruitment of the virtual confocal slits, such that a novel TLSM, which can both improve the imaging efficiency and relax the synchronization requirement for using discontinuous light sheets.

The SLM 401 may further be configured to load a combined phase map superimposed with a spherical phase, so as to implement the creation of the non-coaxial excitation beam arrays together with tiling the discontinuous light sheet in the propagation direction of the excitation light in case that tiling is needed to image the entire image plane.

As shown in FIG. 5(a)-FIG. 5(d), FIG. 6(a)-FIG. 6(d), FIG. 7(a)-FIG. 7(d), FIG. 8, and FIG. 9, an example of the pupil segmentation method is provided, wherein the rear pupil of the excitation objective is divided to 4 groups of evenly distributed radial segments. Although in this example, for each group of pupil segments of the rear pupil, the pupil segments are radial segments evenly distributed circumferentially, the pupil segments could be other configurations or shapes and other group number, as long as the pupil segments are evenly distributed and assigned to different segment groups.

To obtain a non-coaxial beam array, the phased map applied to the SLM is obtained by combining multiple phase maps applied to different groups of pupil segments, so that each group of pupil segments generate one of the excitation beams within the non-coaxial beam array. As shown in FIG. 5(a)-FIG. 5(d), a four-beam non-coaxial beam array is generated by dividing the rear pupil of the excitation objective to four groups of evenly distributed radial segments. For each group of pupil segments of the rear pupil, the pupil segments are radial segments evenly distributed with a first shift angle interval in the circumferential direction, and each group of pupil segments as a whole departs from the adjacent group of pupil segments in the circumferential direction by a second shift angle interval, see the amplitude mask 1, amplitude mask 2, amplitude mask 3, and amplitude mask 4.

Each radial segment has a radian angle of 360°/(m×n), m is the total group number (e.g., 4 in FIG. 5(a)-FIG. 5(d)), n is the number of the radial segments in each group (e.g., 64 in FIG. 5(a)-FIG. 5(d)), the first shift angle interval is 360°/n, and the second angle interval is 360°/(m×n).

Four phase maps, which can be either continuous phase maps (as shown in FIG. 6(a)-FIG. 6(d)) or binary phase maps (as shown in FIG. 7(a)-FIG. 7(d)), are combined into one phase map (as shown in FIG. 8 and FIG. 9). Particularly, the sum of the phase maps to be loaded to the multiple groups of pupil segments weighted with the corresponding amplitude masks is calculated as the combined phase map.

The combined phase map is applied to the SLM to obtain a four-beam non-coaxial beam array, the XY MIP of which is shown in FIG. 10 and the YZ MIP of which is shown in FIG. 11, with the excitation numerical aperture (NA):NA_{od}=0.06, NA_{id}=0.02.

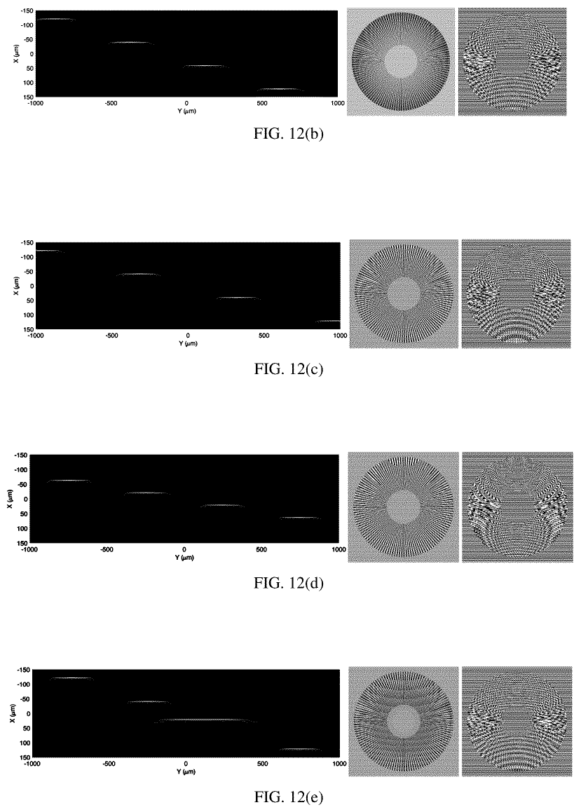

FIG. 12(a) shows the XY MIP of the non-coaxial beam array with a reference intensity file of all beams, the corresponding applied continuous phase map and binary phase map according to a fifth embodiment of the present disclosure. Compared to the reference non-coaxial beam array as shown in FIG. 12(a), various properties of the generated non-coaxial beam array is adjusted by applying different (modified combined) phase maps calculated using the described pupil segmentation method, including but not limited to the excitation beam intensity profile, tiling position (as shown in FIG. 12(b)), beam array period (as shown in FIG. 12(c)), beam array gap distance (as shown in FIG. 12(d)), properties of individual beams (as shown in FIG. 12(c)) and the number of excitation beams (as shown in FIG. 12(f)).

Particularly, the TLSM may further comprise a processor, which is configured to modify the combined phase map to adjust at least one of the following properties of the non-coaxial excitation beam array: the number of the excitation beams, the period of the non-coaxial excitation beam array in the light propagation direction, the gap distance between the adjacent excitation beams along the beam array scanning direction and the intensity profile of each excitation beam.

In some embodiments, the separation of the excitation beams along the scanning direction can not only reduce the crosstalk between them but also enable them to stay closer along the excitation light propagation direction due to the reduced crosstalk. Since the adjacent excitation beams are close to each other enough, or even become contiguous to each other, so that the tiling of the discontinues light sheets is no longer necessary, which reduces the work load (e.g., requirement on the calculation speed) of the SLM. Accordingly, if the light sheet tiling is not needed, a continuous phase SLM could also be used in TLSM, as continuous SLM is more energy and control efficient than binary phase SLM, but with a lower refreshing speed. As a contrast, if tiling is needed, the binary phase SLM is preferred for ensuring the quick switch of the phase maps.

In some embodiments, the adjacent excitation beams even may be overlapped in case that the tail of each excitation beam does not overlap with the waist portion of the adjacent excitation beam in the light propagation direction. If the width of the regional virtual confocal slits is controlled to be proper, the crosstalk may still be efficiently confined and reduced.

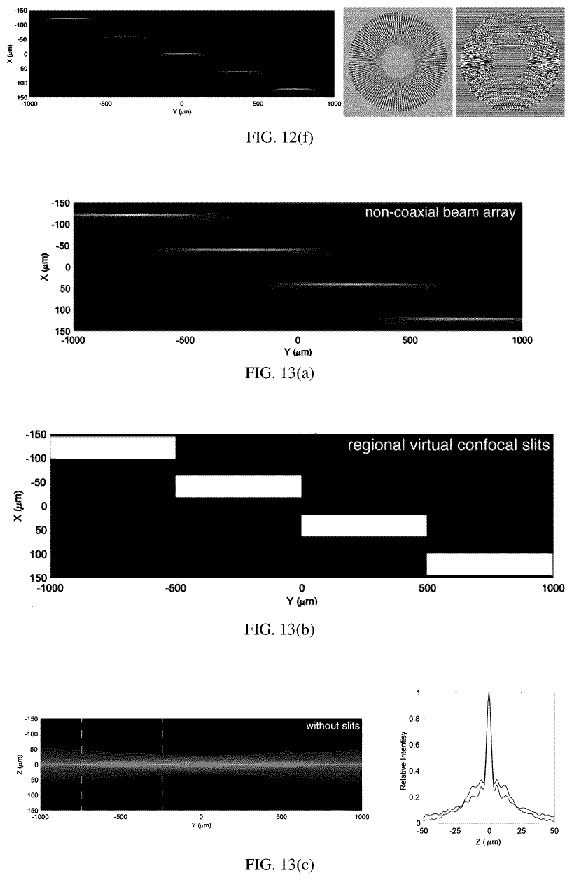

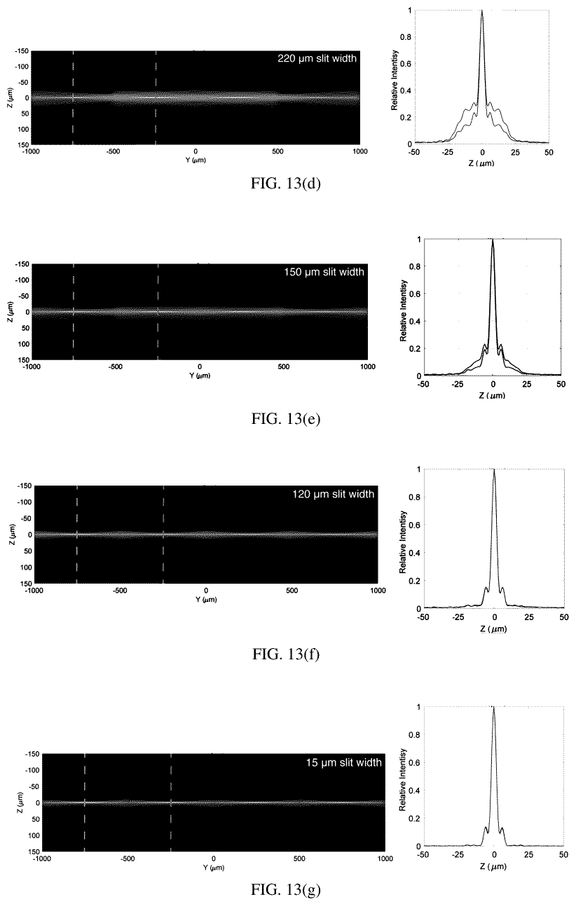

FIG. 13(a) shows the XY MIP of a four-beam non-coaxial beam array with 500 μm period and 80 μm gap distance according to a sixth embodiment of the present disclosure. FIG. 13(b) shows the regional virtual confocal slits with variable widths in the X direction according to the sixth embodiment of the present disclosure. The excitation NA is set as NA_{od}=0.06 and NA_{id}=0.02.

The intensity profile and thickness of the discontinuous light sheets obtained by scanning the non-coaxial beam array in FIG. 13(a) synchronized with the regional virtual confocal slits in FIG. 13(b) of various widths (see FIG. 13(c)-FIG. 13(g)) are compared, so as to evaluate whether the proposed TLSM and its imaging method could work as expected to reject the off-focus fluorescence and how efficient the off-focus fluorescence is blocked at different confocal slit widths.

FIG. 13(c) shows the YZ MIP of the discontinuous light sheet obtained by scanning the non-coaxial beam array in FIG. 13(a) without slits and the intensity profiles at the positions indicated by the dashed lines. FIG. 13(d) shows the YZ MIP of the discontinuous light sheet obtained by scanning the non-coaxial beam array in FIG. 13(a) synchronized with the regional virtual confocal slits in FIG. 13(b) of 220 μm slit width and the intensity profiles at the positions indicated by the dashed lines. FIG. 13(e) shows the YZ MIP of the discontinuous light sheet obtained by scanning the non-coaxial beam array in FIG. 13(a) synchronized with the regional virtual confocal slits in FIG. 13(b) of 150 μm slit width and the intensity profiles at the positions indicated by the dashed lines. FIG. 13(f) shows the YZ MIP of the discontinuous light sheet obtained by scanning the non-coaxial beam array in FIG. 13(a) synchronized with the regional virtual confocal slits in FIG. 13(b) of 120 μm slit width and the intensity profiles at the positions indicated by the dashed lines. FIG. 13(g) shows the YZ MIP of the discontinuous light sheet obtained by scanning the non-coaxial beam array in FIG. 13(a) synchronized with the regional virtual confocal slits in FIG. 13(b) of 15 μm slit width and the intensity profiles at the positions indicated by the dashed lines.

The results in FIG. 13(c)-FIG. 13(g) show that the regional virtual confocal slits reject the off-focus fluorescence background efficiently until the slit width reaches 120 μm, which is about 1.5 times of the beam array gap distance. That is to say, the width of each regional virtual confocal slit in the scanning direction could be as wide as 1.5 times of the gap distance of the non-coaxial excitation beam array. Thus, the strict requirement of the width of each regional virtual confocal slit and the synchronization with the scanning beam array are obviously relaxed. Further, the geometry (e.g., the width, the length, etc.) of the multiple regional virtual confocal slits may match the intensity profile of the non-coaxial excitation beam array, so as to reject the off-focus fluorescence background efficiently.

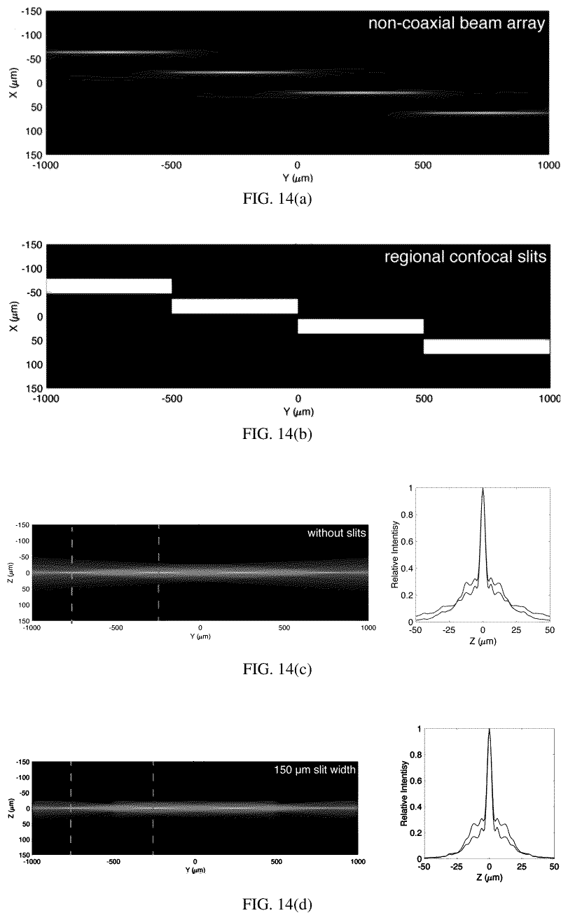

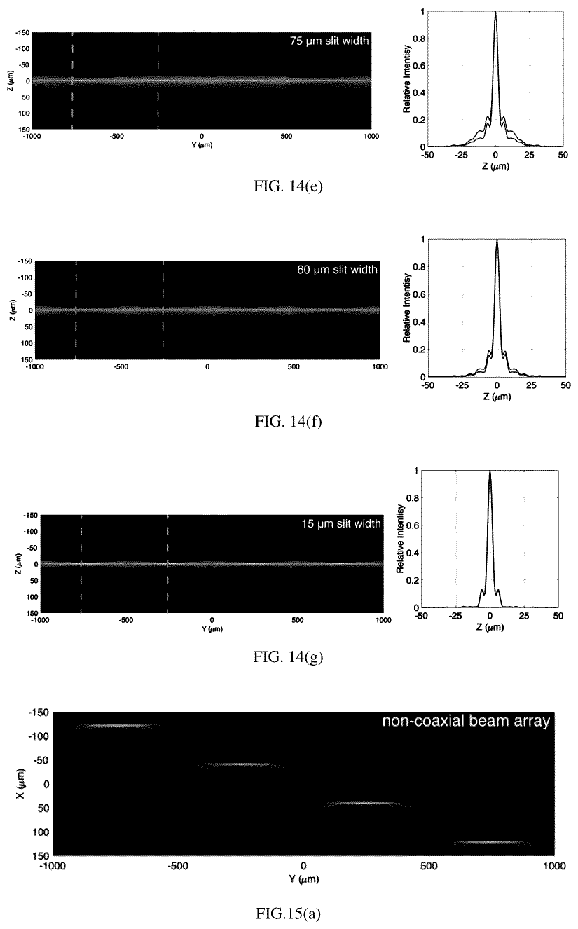

Further, the influence of the beam array gap distance on the intensity profile of the discontinuous light sheets obtained by the synchronized scan of the non-coaxial beam array and regional virtual confocal slits is evaluated. The intensity profile and thickness of the discontinuous light sheets obtained by scanning the non-coaxial beam array in FIG. 14(a), which consists of the same excitation beams as that in FIG. 13(a) but with a half of the gap distance, synchronized with the regional confocal slits in FIG. 14(b) of various widths. The excitation NA is also set as NA_{od}=0.06 and NA_{id}=0.02.

The results in FIG. 14(c)-FIG. 14(g) show that the regional virtual confocal slits reject the off-focus fluorescence efficiently until the slit width reaches about 1.5 times of the beam array gap distance, which is about 60 μm. Therefore, it is confirmed that narrower slits are needed to reject the off-focus fluorescence generated by non-coaxial beam arrays with short gap distances efficiently. Obviously, the synchronization of scanning non-coaxial beam arrays with larger gap distances and regional confocal slits with larger widths is easier and more robust although the imaging time is increased a little due to the longer scanning distance of the beam array. On the other hand, 3D imaging using regular continuous light sheets in TLSM can be considered as imaging using non-coaxial beam arrays with the gap distance larger than the height of the detection camera FOV

Moreover, the influence of the intensity profile (such as the thickness) of the individual excitation beams on the efficiency of the regional virtual confocal slits in rejecting the off-focus fluorescence is evaluated. Particularly, it is further investigated whether narrower regional confocal slits are needed to block the off-focus fluorescence generated by non-coaxial beam arrays that consist of thinner excitation beams.

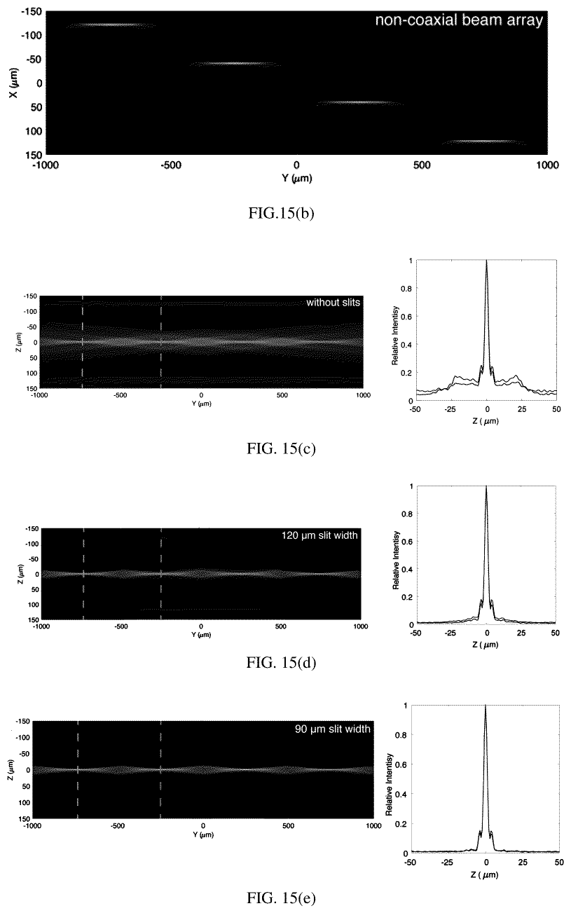

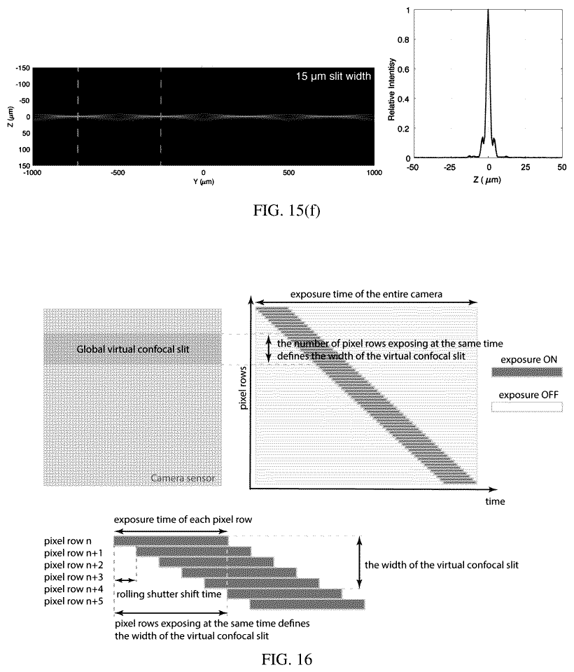

The intensity profiles of the discontinuous light sheets obtained by synchronized scan of the non-coaxial beam array in FIG. 15(a) with the regional confocal slits in FIG. 15(a) of various widths are evaluated. The excitation NA is set as NA_{od}=0.09 and NA_{id}=0.03. In FIG. 15(a), the non-coaxial beam array consists of thinner excitation beams than that of the non-coaxial beam array in FIG. 13(a), but has the same beam number, gap distance and beam array period. The results in FIG. 15(c), FIG. 15(d), FIG. 15(c), and FIG. 15(f) show that the regional confocal slits also block the off-focus fluorescence background efficiently until the width of the slits reaches roughly 1.5 times of the beam array gap distance despite the slightly higher background, which suggests the off-focus fluorescence rejection efficiency by reginal confocal slits is unrelated to (barely affected by) the intensity profile of individual excitation beams within the non-coaxial beam array.

The multiple regional virtual confocal slits are controlled by means of the rolling shutter(s) of sCMOS cameras. There are various manners to implement the multiple regional virtual confocal slits, which are developed from but different from the working mechanism of the global virtual confocal slit that is controlled by the global rolling shutter of the detection camera.

As shown in FIG. 16, in conventional sCMOS cameras, a global rolling shutter is used to control the exposure of the camera pixels, and different rows of camera pixels are exposed sequentially at different times as the rolling shutter sweeps through the camera sensor. The usage of a global rolling shutter produces a detection effect that is equivalent to the use a sweeping global virtual confocal slit. The sweeping speed of the global virtual confocal slit can be adjusted by changing the shift time of the rolling shutter. Both the shift time of the rolling shutter and the exposure time of each pixel row determine the number of pixel rows exposing at the same time, which define the width of the global virtual confocal slit. For instance, the sweeping speed of the virtual confocal slit can be increased by decreasing the rolling shutter shift time. The width of the global virtual confocal slit can be decreased by either increasing the rolling shutter shift time or decreasing the exposure time of each pixel row, so that less pixel rows are exposed at the same time which produces a narrower global virtual confocal slit.

As an example, the detection camera may comprise (adopt) a single sCMOS camera with multiple rolling shutters to control the exposure of the different pixel rows in different regions, so as to obtain the multiple regional virtual confocal slits. As shown in FIG. 17, the detection camera is separated to four column regions, i.e., region 1, region 2, region 3, and region 4, and the exposure of the four regions are controlled by four rolling shutters separately, which results in the realization of four regional virtual confocal slits. Besides the sweeping speed and width of each regional confocal slit are controlled by the corresponding rolling shutter individually, the gap distance between the adjacent regional virtual confocal slits is controlled by both the difference of the exposure initiation time and the shift time of different rolling shutters.

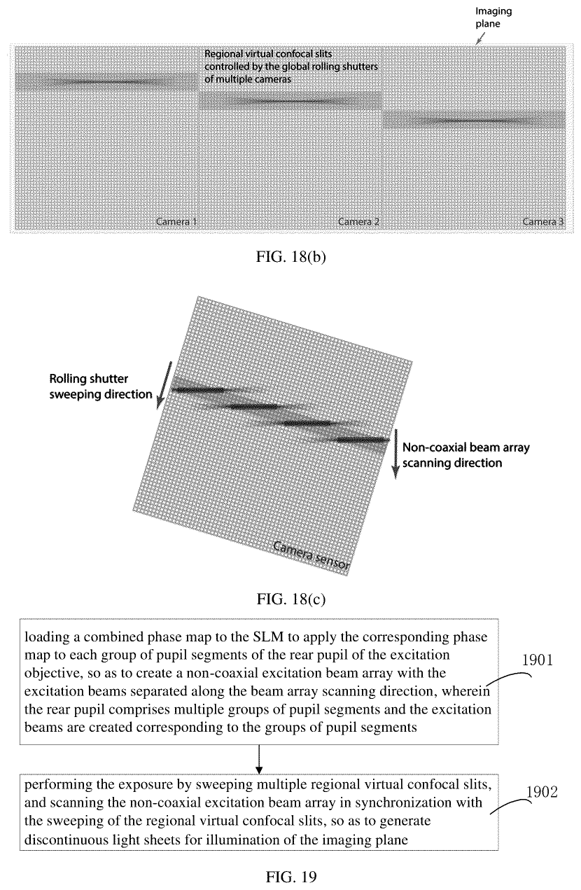

Obviously, the proposed method/TLSM can be realized directly by using a scanning non-coaxial beam array synchronized with the regional virtual confocal slits on a sCMOS camera equipped with multiple rolling shutters (see FIG. 18(a), one camera sensor-four excitation beams-four regional virtual confocal slits). The higher the number of rolling shutters, the more regional virtual confocal slits can be obtained, and the more excitation beams can be included in a non-coaxial beam array to improve the imaging efficiency of TLSM.

As another example, the detection camera could be a camera assembly instead of a camera unit, i.e., it may comprise multiple sCMOS camera units (or sCMOS cameras), each of which is equipped with a rolling shutter and cooperates to control the exposure of the different pixel rows in different regions, so as to obtain the multiple regional virtual confocal slits. it is possible to use multiple sCMOS cameras for image detection (see FIG. 18(b)), so that the global rolling shutter of each sCMOS camera controls one of the multiple regional virtual confocal slits, i.e., the global virtual confocal slit of each sCMOS camera just serves as one of the multiple regional virtual confocal slits. As shown in FIG. 18(b), for each one of cameras 1-3, there may be a single excitation beam as well as a single virtual confocal slit (which could be referred to as multiple “pseudo” virtual confocal slits).

As further another example, the detection camera is an sCMOS camera equipped with a single rolling shutter, the sweeping direction of which forms a non-zero mismatch angle with respect to the scanning direction of the non-coaxial excitation beam array, so as to obtain an oblique global virtual confocal slit, the different regions in which work as the multiple regional virtual confocal slits (which are referred to as multiple “pseudo” virtual confocal slits). That is to say, the multiple regional virtual confocal slits can also be obtained by mismatching the non-coaxial beam array scanning direction and the rolling shutter sweeping direction of a sCMOS camera (see FIG. 18(c)), so that the different regions within a single global virtual confocal slit can work as multiple regional virtual confocal slits due to the mismatching.

In some embodiments, the width, exposure initiation, exposure termination and shifting speed of each regional confocal slit can be adjusted according to the scanning speed and the gap distance of the non-coaxial beam array, so that the sweeping of the slits, corresponding to the exposure of the pixel rows in different regions of the detection camera, can be synchronized with the scanning of the non-coaxial beam array.

FIG. 19 shows the flowchart of the imaging method of a TLSM according to the tenth embodiment of the present disclosure. The TLSM may comprises a spatial light modulator (SLM) for performing phase modulation on the excitation laser beam, a galvanometer, an excitation objective, and a detection camera, the optical modulation plane of the SLM is conjugated to the rear pupil of the excitation objective. Regarding the configuration of the TLSM supporting this imaging method, the details in other embodiments of present disclosure may be incorporated here.

As shown in FIG. 19, the imaging method may comprise the following steps.

At step 1901, a combined phase map is loaded to the SLM to apply the corresponding phase map to each group of pupil segments of the rear pupil of the excitation objective, so as to create a non-coaxial excitation beam array with the excitation beams separated along the beam array scanning direction (sometimes also separated along the light propagation direction and). The rear pupil comprises multiple groups of pupil segments and the excitation beams are created accordingly by the different groups of pupil segments.

At step 1902, the exposure is performed by sweeping multiple regional virtual confocal slits, and the scanning of the non-coaxial excitation beam array is synchronized with the sweeping of the regional virtual confocal slits, so as to generate discontinuous light sheets for illumination and imagination of the imaging plane.

In some embodiments, scanning the non-coaxial excitation beam array may further comprise scanning each excitation beam within the non-coaxial excitation beam array in synchronization with the sweeping timing of the corresponding virtual confocal slit.

In some embodiments, sweeping multiple regional virtual confocal slits may further comprise confining the width of each regional virtual confocal slit in the scanning direction to be at most as wide as 1.5 times of the gap distance of the non-coaxial excitation beam array.

In some embodiments, sweeping of the multiple regional virtual confocal slits is performed so as to match the geometry of the multiple regional virtual confocal slits to the intensity profile of the non-coaxial excitation beam array.

In some embodiments, the regional virtual confocal slits are separated from each other along the scanning direction, sweeping the multiple regional virtual confocal slits may further comprise at least one of the following: controlling the exposure of the different pixel rows in different regions by means of multiple rolling shutters provided in a single sCMOS camera; controlling the exposure of the different pixel rows in different regions by means of multiple sCMOS camera units, each of which is equipped with a rolling shutter; and obtaining an oblique global virtual confocal slit, the different regions in which work as the multiple regional virtual confocal slits, by means of an sCMOS camera equipped with a single rolling shutter, the sweeping direction of which forms a non-zero mismatch angle with respect to the scanning direction of the non-coaxial excitation beam array.

In some embodiments, sweeping the multiple regional virtual confocal slits may further comprise: controlling the rolling shutters to adjust at least one of the width, exposure initiation, exposure termination and shifting speed of each regional virtual confocal slit according to the scanning speed and the gap distance between adjacent excitation beams along the scanning direction, so as to synchronize the sweeping of the regional virtual confocal slits with the scanning of the non-coaxial excitation beam array.

The details of the imaging process demonstrated in combination with the TLSM according to any embodiment of the present disclosure may be incorporated herein and thus omitted.

In some embodiments, a tiling light sheet microscopy system is provided, which comprises the TLSM according to any embodiment of present disclosure and at least one processor.

The at least one processor is configured to simulate the combined phase map by calculating the sum of the phase maps to be loaded to the multiple groups of pupil segments weighted with the corresponding amplitude masks.

In some embodiments, the processor may be processing device including one or more general processing device, such as microprocessor, central processing unit (CPU), graphics processing unit (GPU) and so on. More specifically, the processor may be complex instruction set computing (CISC) microprocessor, reduced instruction set computing (RISC) microprocessor, very long instruction word (VLIW) microprocessor, processor running other instruction sets or a combination of instruction sets. The processor may also be one or more dedicated processing device, such as application specific integrated circuit (ASIC), field programmable gate array (FPGA), digital signal processor (DSP), system on chip (SoC) and so on.

In some embodiments, the detection camera 405 as shown in FIG. 4 may have various configurations.

Returning to FIG. 17, FIG. 18(a), FIG. 18(b) and FIG. 18(c), the detection camera 405 includes a camera sensor, at least one rolling shutter, and at least one controller (not illustrated), the at least one controller is configured to control the at least one rolling shutter to perform the sweeping of multiple regional virtual confocal slits, which are able to be separated from each other along the sweeping direction of the regional virtual confocal slits. That is to say, the multiple regional virtual confocal slits may be inherently separated from each other along the sweeping direction of the regional virtual confocal slits, or may be manually designed as being separated from each other along the sweeping direction of the regional virtual confocal slits (see the configuration of FIG. 18(c), the details of which will be provided hereinafter).

As shown in FIG. 18(a), in some embodiments, the detection camera 405 comprises a single sCMOS camera with multiple rolling shutters and one controller, the controller is further configured to control the multiple rolling shutters to perform exposure of the different pixel rows in different regions of the camera sensor, so as to obtain the multiple regional virtual confocal slits.

As shown in FIG. 18(b), in some embodiments, the detection camera 405 comprises multiple sCMOS camera units, each of which is equipped with a single rolling shutter, and at least one controller, which is configured to control the individual rolling shutter of each sCMOS camera unit to perform exposure of the different pixel rows in different regions of the camera sensor, so as to obtain the multiple regional virtual confocal slits.

As an example, as shown in FIG. 17, the different regions include different pixel columns.

As shown in FIG. 18(c), in some embodiments, the detection camera 405 comprises an sCMOS camera equipped with a single rolling shutter and a single controller, the single controller is configured to control the single rolling shutter to make the sweeping direction form a non-zero mismatch angle with respect to a beam array scanning direction, so as to obtain an oblique global virtual confocal slit, the different regions (parts) in which work as the multiple regional virtual confocal slits.

The detection camera 405 as above may be used for the tiling light sheet microscope according to any embodiment of present disclosure, and the multiple regional virtual confocal slits are separated from each other along the beam array scanning direction. As an example, the beam array scanning direction may be consistent with the sweeping direction of the multiple regional virtual confocal slits, as shown in FIG. 18(a) and FIG. 18(b). As another example, the beam array scanning direction may be inconsistent with the sweeping direction of the multiple regional virtual confocal slits, as shown in FIG. 18(c), a mismatch angle is formed.

In some embodiments, the at least one controller is further configured to synchronize the sweeping timing of the corresponding virtual confocal slit with the scanning timing of each excitation beam within the non-coaxial excitation beam array.

In some embodiments, the at least one controller is further configured to control the rolling shutter(s) to adjust at least one of the width, exposure initiation, exposure termination and shifting speed of each regional virtual confocal slit according to the scanning speed and the gap distance between adjacent excitation beams along the scanning direction, so as to synchronize the sweeping of the regional virtual confocal slits with the scanning of the non-coaxial excitation beam array.

In some embodiments, the controller may be processing device including one or more general processing device, such as microprocessor. More specifically, the processor may be complex instruction set computing (CISC) microprocessor, reduced instruction set computing (RISC) microprocessor, very long instruction word (VLIW) microprocessor, processor running other instruction sets or a combination of instruction sets. The controller may also be one or more dedicated processing device, such as application specific integrated circuit (ASIC), field programmable gate array (FPGA), digital signal processor (DSP), system on chip (SoC) and so on.

The above description is intended to be illustrative and not limiting. For example, the above-mentioned examples (or one or more solutions thereof) may be used in combination with each other. For example, those of ordinary skill in the art may use other embodiments when reading the above-mentioned description. In addition, in the above-mentioned specific embodiments, various features may be grouped together to simplify the present disclosure. This should not be interpreted as an intention that features of the disclosure that do not require protection are necessary for any of the claims. Rather, the subject matter of the present disclosure may be less than the full range of features of a particular disclosed embodiment. Therefore, the following claims are incorporated herein as examples or embodiments in the particular embodiment, each claim stands alone as a separate embodiment, and it is contemplated that these embodiments may be combined with each other in various combinations or permutations. The scope of the present invention shall be determined by reference to the full scope of the appended claims and equivalent forms to which these claims are entitled.

The above embodiments are only exemplary embodiments of the present disclosure, and are not used to limit the present invention. The scope of protection of the invention is defined by the claims. Those skilled in the art can make various modifications or equivalent substitutions to the invention within the essence and protection scope of the disclosure, and such modifications or equivalent substitutions should also be regarded as falling within the protection scope of the invention.

1. A tiling light sheet microscope, comprising: a spatial light modulator (SLM) for performing phase modulation on an excitation laser beam, a galvanometer, an excitation objective, and a detection camera, an optical modulation plane of the SLM is conjugated to a rear pupil of the excitation objective, wherein,
the SLM is configured to: load a combined phase map to implement loading of a corresponding phase map to each group of pupil segments of the rear pupil of the excitation objective, so as to create a non-coaxial excitation beam array with the excitation laser beams separated along a scanning direction, wherein the rear pupil comprises multiple groups of pupil segments and the excitation laser beams are created corresponding to the groups of pupil segments;
the detection camera is configured to perform an exposure by sweeping multiple regional virtual confocal slits; and
the galvanometer is configured to: scan the non-coaxial excitation beam array synchronized with the sweeping of the regional virtual confocal slits, wherein scanning of each excitation laser beam is synchronized with sweeping timing of a corresponding one of the regional virtual confocal slits, so as to generate discontinuous light sheets for illumination of an imaging plane.

2. (canceled)

3. The tiling light sheet microscope of claim 1, wherein, a width of each regional virtual confocal slit in the scanning direction is able to be as large as 1.5 times of a gap distance of the non-coaxial excitation beam array.

4. The tiling light sheet microscope of claim 1, wherein, a geometry of the multiple regional virtual confocal slits matches an intensity profile of the non-coaxial excitation beam array.

5. The tiling light sheet microscope of claim 1, wherein, regional virtual confocal slits are separated from each other along the scanning direction, and the detection camera comprises a single sCMOS camera with multiple rolling shutters to control exposure of different pixel rows in different regions, so as to obtain the multiple regional virtual confocal slits.

6. The tiling light sheet microscope of claim 1, wherein, regional virtual confocal slits are separated from each other along the scanning direction, and the detection camera comprises multiple sCMOS camera units, each of which is equipped with a rolling shutter and cooperates to control exposure of different pixel rows in different regions, so as to obtain the multiple regional virtual confocal slits.

7. The tiling light sheet microscope of claim 1, wherein, the detection camera is an sCMOS camera equipped with a single rolling shutter, a sweeping direction of which forms a non-zero mismatch angle with respect to the scanning direction of the non-coaxial excitation beam array, so as to obtain an oblique global virtual confocal slit, different regions in which work as the multiple regional virtual confocal slits.

8. (canceled)

9. (canceled)

10. (canceled)

11. The tiling light sheet microscope of claim 4, wherein, the detection camera is further configured to control the rolling shutters to adjust at least one of width, exposure initiation, exposure termination and shifting speed of each regional virtual confocal slit according to a scanning speed and gap distance between adjacent excitation laser beams along the scanning direction, so as to synchronize the sweeping of the regional virtual confocal slits with the scanning of the non-coaxial excitation beam array.

12. The tiling light sheet microscope of claim 1, wherein, for each group of pupil segments of the rear pupil, the pupil segments are radial segments evenly distributed with a first shift angle interval in a circumferential direction, and each group of pupil segments as a whole departs from adjacent group of pupil segments in the circumferential direction by a second shift angle interval.

13. (canceled)

14. (canceled)

15. (canceled)

16. The tiling light sheet microscope of claim 1, further comprising a processor, which is configured to modify the combined phase map to adjust at least one of the following properties of the non-coaxial excitation beam array:
a number of excitation laser beams, a period of the non-coaxial excitation beam array in a light propagation direction, a gap distance between adjacent excitation laser beams along a beam array scanning direction and an intensity profile of each excitation laser beam.

17. An imaging method of a tiling light sheet microscope, comprising a spatial light modulator (SLM) for performing phase modulation on an excitation laser beam, a galvanometer, an excitation objective, and a detection camera, an optical modulation plane of the SLM is conjugated to a rear pupil of the excitation objective, the imaging method comprising:
loading a combined phase map to the SLM to apply a corresponding phase map to each group of pupil segments of the rear pupil of the excitation objective, so as to create a non-coaxial excitation beam array with the excitation laser beams separated along a beam array scanning direction, wherein the rear pupil comprises multiple groups of pupil segments and the excitation laser beams are created corresponding to the groups of pupil segments;
performing an exposure by sweeping multiple regional virtual confocal slits, and scanning the non-coaxial excitation beam array in synchronization with a sweeping timing of corresponding one of the regional virtual confocal slits, so as to generate discontinuous light sheets for illumination of an imaging plane.

18. (canceled)

19. The imaging method of claim 17, wherein, sweeping multiple regional virtual confocal slits further comprises confining a width of each regional virtual confocal slit in the scanning direction to be at most as large as 1.5 times of a gap distance of the non-coaxial excitation beam array.

20. The imaging method of claim 17, wherein, sweeping multiple regional virtual confocal slits further comprises matching a geometry of the multiple regional virtual confocal slits to an intensity profile of the non-coaxial excitation beam array.

21. The imaging method of claim 17, wherein, the regional virtual confocal slits are separated from each other along the scanning direction, sweeping the multiple regional virtual confocal slits further comprises at least one of the following:
controlling exposure of different pixel rows in different regions by means of multiple rolling shutters provided in a single sCMOS camera;
controlling exposure of different pixel rows in different regions by means of multiple sCMOS camera units, each of which is equipped with a rolling shutter;
obtaining an oblique global virtual confocal slit, the different regions in which work as the multiple regional virtual confocal slits, by means of an sCMOS camera equipped with a single rolling shutter, the sweeping direction of which forms a non-zero mismatch angle with respect to the scanning direction of the non-coaxial excitation beam array.

22. The imaging method of claim 21, wherein, sweeping the multiple regional virtual confocal slits further comprises: controlling the rolling shutters to adjust at least one of width, exposure initiation, exposure termination and shifting speed of each regional virtual confocal slit according to a scanning speed and a gap distance between adjacent excitation laser beams along the scanning direction, so as to synchronize the sweeping of the regional virtual confocal slits with the scanning of the non-coaxial excitation beam array.

23. (canceled)

24. A detection camera including a camera sensor, at least one rolling shutter, and at least one controller, the at least one controller is configured to control the at least one rolling shutter to perform sweeping of multiple regional virtual confocal slits, which are able to be separated from each other along a sweeping direction of the regional virtual confocal slits;
the detection camera is used for the tiling light sheet microscope of claim 1, and the multiple regional virtual confocal slits are separated from each other along the scanning direction;
the at least one controller is further configured to synchronize the sweeping timing of the corresponding one of the regional virtual confocal slits with a scanning timing of each excitation laser beam within the non-coaxial excitation beam array.

25. The detection camera of claim 24, wherein, the detection camera comprises a single sCMOS camera with multiple rolling shutters and one controller, the controller is further configured to control the multiple rolling shutters to perform exposure of different pixel rows in different regions of the camera sensor, so as to obtain the multiple regional virtual confocal slits.

26. The detection camera of claim 24, wherein, the detection camera comprises multiple sCMOS camera units, each of which is equipped with a single rolling shutter, and at least one controller, which is configured to control the respective rolling shutter of each sCMOS camera unit to perform exposure of different pixel rows in different regions of the camera sensor, so as to obtain the multiple regional virtual confocal slits.

27. The detection camera of claim 24, wherein, the detection camera comprises an sCMOS camera equipped with a single rolling shutter and a single controller, the single controller is configured to control the single rolling shutter to make the sweeping direction form a non-zero mismatch angle with respect to a beam array scanning direction, so as to obtain an oblique global virtual confocal slit, different regions in which work as the multiple regional virtual confocal slits.

28. (canceled)

29. (canceled)

30. The detection camera of claim 24, wherein, the at least one controller is further configured to control the rolling shutter(s) to adjust at least one of width, exposure initiation, exposure termination and shifting speed of each regional virtual confocal slit according to a scanning speed and a gap distance between adjacent excitation laser beams along the scanning direction, so as to synchronize the sweeping of the regional virtual confocal slits with the scanning of the non-coaxial excitation beam array.

31. The detection camera of claim 25, wherein, the different regions include different pixel columns.
